(19) United States
(12) Patent Application Publication
(10) Pub. No.: US 2004/0237096 A1
(43) Pub. Date: Nov. 25, 2004

(54) Automated in-home observation of user interactions with video devices

(75) Inventors: Michael E. Cain, Arvada, CO (US); Monica Ann Marics, Boulder, CO (US)

Correspondence Address: BROOKS KUSHMAN P.C., 1000 TOWN CENTER, TWENTY-SECOND FLOOR, SOUTHFIELD, MI, 48075, US

(73) Assignee: Comcast Cable Holdings, LLC, Philadelphia, PA (US)

(21) Appl. No.: 10/441,402

(22) Filed: May 20, 2003

(51) Int. Cl. H04N 7/16; H04N 5/445; G06F 3/00

(52) U.S. Cl. 725/13; 725/9; 725/14; 725/37; 725/12

(57) ABSTRACT

A computer-based method of monitoring and recording user interaction with a video service device is provided. The video service device is connected to a display. The computer is programmed to monitor and selectively record information received from the video service device, a video camera, and a remote control signal detector. The computer-based method includes, over a period of time, detecting a plurality of remote control signals indicative of button clicks, grabbing first video frames from the video service device, and grabbing second video frames from the video camera. The detected remote control signals, the first video frames, and the second video frames are recorded to the storage medium as a sequence of events while preserving the time relationship among the various events with respect to each other thereby establishing a common time base for the recorded sequence of events.

### BACKGROUND OF THE INVENTION

1. Field of the Invention

The present invention relates to observing and recording the interaction between a person and a sophisticated video device (e.g. a digital set top box) using an infrared remote control.

2. Background Art

In providing an efficient and satisfactory video service such as digital cable or satellite television, it is essential that providers are able to understand and cater to the needs of users. In order to accomplish this, observation systems for monitoring and recording interactions of persons with sophisticated video service devices such as digital set top boxes are used.

Existing processes for performing this type of observation involve having the person complete a paper log showing what they watched and when or involve the use of multiple devices such as video cameras, video tape recorders, and video mixing consoles in order to acquire information. The paper log approach is limited by a person's motivation and memory. However, in the multiple device approach time synchronization among the different data acquisition devices can be a problem. Also, not all types of user events are recorded and, as a result, the variety of analysis may be limited. Further, video service devices implement a complex collection of interactive menus. The full range of possible transitions from one menu to others will not generally be known in advance.

For the foregoing reasons, there is a need for an improved method of monitoring and recording user interaction with a video service device.

### SUMMARY OF THE INVENTION

It is therefore an object of the present invention to provide a computer-based method of monitoring and recording user interaction with a video service device wherein events from multiple devices are recorded to the storage medium as a sequence while preserving the time relationship among the various events with respect to each other to thereby establish a common time base for the recorded sequence of events.

In carrying out the present invention, a computer-based method of monitoring and recording user interaction with a video service device is provided. Relevant information is recorded to a storage device as a sequence of events that maintains the time relationship among each recorded piece of data. The storage device may be part of the computer or remote storage. The computer is further equipped with a first video frame grabber, and a second video frame grabber. The first video frame grabber is connected to the video service device while the second video frame grabber is connected to a video camera. A remote control signal detector is connected to the computer. The video service device may be any device (for example, set top box, personal video recorder, video tape recorder, etc.) so long as direct or baseband video output is provided to the first video frame grabber. In this way, the first video frame grabber is directly monitoring the same video that the person is watching. Further, the invention comprehends that, in the same way, multiple video service devices may be monitored so long as the appropriate direct or baseband video output is provided to the first video frame grabber.

Remote control signals indicative of remote control button clicks by the user are detected over a period of time. A plurality of first video frames are grabbed by the first video frame grabber from the video service device. A plurality of second video frames are grabbed by the second video frame grabber from the video camera. The information including the detected remote control signals, the first video frames, and the second video frames is then recorded to the storage device as a sequence of events over a period of time while maintaining the time relationship among the various events with respect to each other and thereby establishing a common time base for the recorded sequence of events. The remote control signals may be presented and recorded as raw signals or may be interpreted and the resultant interpretation recorded.

At a more detailed level, the invention comprehends additional features as further explained below. These additional features are optional.

In order to increase the probability of capturing adequate and useful information for analysis, a sequence of first video frames is grabbed by the first video frame grabber from the video service device in response to a remote control signal indicative of a remote control button click being detected by the remote control signal detector. If a remote control signal is detected by the remote control signal detector while the first video frame grabber is grabbing the sequence of first video frames, a counter is restarted such that the grabbed sequence of video frames extends beyond the additional remote control signal detection. The sequence of first video frame grabs is then recorded to the storage medium. That is, in the case of a single click, one frame is captured immediately and additional frames are captured at predetermined intervals to form the sequence. The additional frame capture schedule starts over if another button click occurs before the scheduled captures are completed.

Capturing images from the video service device is helpful when tracking user interaction with the service control software. It is not sufficient to record just remote control events because depending on where the remote control signal detector is positioned relative to the service delivery device, a signal may be detected by one device but not the other. Some digital set top boxes are known to ignore subsequent remote control signals during intervals while processing an event. Recording the menu progression as a sequence of images makes subsequent analysis of user actions feasible. Captured images from the video service device may be used to determine the tuned channel by capturing a sequence of channel grid screens or capturing an image of the flip bar that appears when a channel change occurs.

It is also comprehended by the invention to capture snapshots of the user interacting with the video service device. A new video frame from the camera is grabbed by the second video frame grabber at regular intervals. In certain circumstances, the latest video frame is recorded. In particular, the latest video frame is recorded if a remote control event occurred between the previous snapshot and the current snapshot or if the current snapshot is significantly different than the previous snapshot.

In determining a motion differential between consecutive snapshots or frames, the particular second video frame grabbed by the second video frame grabber from the video camera is compared with the immediately preceding second video frame. The motion differential criterion acts as a form of motion detection to allow the recorded information to aid in the analysis of patterns of motion in front of the television relative to the pattern of remote control events.

The observation system may be implemented in software running on a computer such as an ordinary PC hardware and the Linux operating system. As such, in addition to the above described methods, the invention further comprehends a computer readable storage medium having instructions stored thereon to direct a computer to perform monitoring and recording of user interaction with the video service device. Of course, the computer hardware and operating system may be any hardware and operating system that are appropriate.

The above object and other objects, features, and advantages of the present invention are readily apparent from the following detailed description of the preferred embodiment when taken in connection with the accompanying drawings.

### BRIEF DESCRIPTION OF THE DRAWINGS

FIG. 1 is a block diagram illustrating an observation system in accordance with the present invention.

FIG. 2 is a flowchart illustrating monitoring and recording in accordance with the present invention.

FIG. 3 is a flowchart illustrating motion detection analysis in accordance with the present invention.

### DETAILED DESCRIPTION OF THE PREFERRED EMBODIMENT

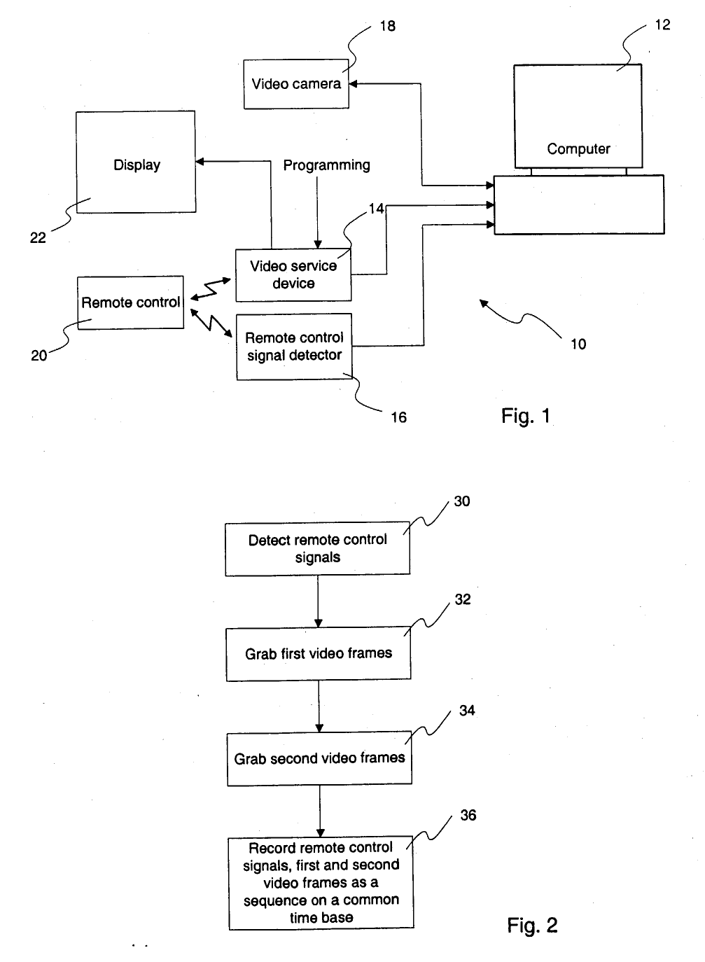

Referring to FIG. 1, a system for unobtrusively monitoring and recording user interaction with a video service device in the preferred embodiment is shown. This system, generally indicated by reference numeral 10, includes a computer 12, a remote control signal detector 16, and a video camera 18. Also shown are video service device 14, a remote control 20, and a display 22. The video service device 14 receives programming from a video service provider and provides programming to a user. The computer 12 includes first and second video frame grabbers for capturing video frames from the video service device 14 and the video camera 18, respectively, and a storage device for recording sequences of events indicating user interaction with the video service device 14. A storage medium within the computer has instructions stored thereon to direct the computer 12 to perform a method of monitoring and recording user interaction with the video service device 14. The sequences of events recorded over a period of time are done so while maintaining the time relationship among the various events with respect to each other and thereby establishing a common time base for the recorded events.

The system 10 is implemented with software running on ordinary PC computer hardware and a Linux operating system. The remote control signal detector 16, which is preferably an infrared receiver, is connected to the computer 12 via a serial port. The video frame grabbers may utilize any suitable techniques for capturing video. For example, camera 18 may connect to computer 12 via USB and video service device 14 may connect to a PCI video capture card.

Remote control signals are detected by the remote control signal detector 16 over a period of time. The remote control signals indicate remote control button clicks by the remote control 20 from a user (not specifically shown). A detected remote control signal acts as a trigger event, which is communicated by the remote control signal detector 16 to the computer 12. The first and the second video frame grabbers capture video frames from the video service device 14 and the video camera 18 and information is selectively recorded from the remote control signal detector 16, the video service device 14, and the video camera 18 to the storage device. Remote control button clicks, video output from the video service device 14, and images of the user from the video camera 18 are all recorded together, on a common time base, to the storage device as a sequence of events.

With reference to FIG. 2, the computer-based method of monitoring and recording user interaction with a video service device in the preferred embodiment is more specifically illustrated. Over a period of time, remote control signals indicative of remote control button clicks are detected by the remote control signal detector at block 30. A plurality of first video frames are grabbed by a first video frame grabber from the video service device at block 32. A plurality of second video frames are grabbed by a second video frame grabber from the video camera at block 34. The detected remote control signals, the first video frames and the second video frames are then recorded to the storage device at block 36 as a sequence of events while preserving the time relationship among the various events with respect to each other thereby establishing a common time base.

Video frames from the video service device are stored in response to button clicks on the remote control. For each remote control signal detected by the remote control signal detector 16, the observation system 10 instructs the capture of one or more video frames from the video service device 14. In the case of a single remote control button click, a series of video frame grabs is captured in which one video frame is captured immediately and additional video frames are captured at intervals of one, two, four, and fifteen seconds after the triggering event has occurred. If another triggering event occurs before the series of video frame grabs are completed, the series of frame grabs starts over. This series of frame grabs helps provide a higher probability that the flipbar viewed on the display which is provided by the program service provider, will be captured. Also, the particular button on the remote control that was pressed will also be recorded to the storage device.

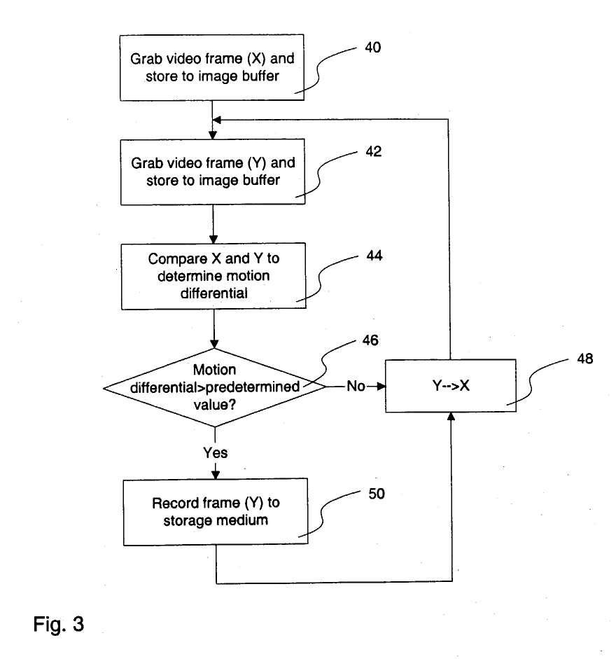

Video frames from the camera are stored in response to a button click preceding a particular video frame and also in response to significant motion between successive frames. For example, FIG. 3 shows the second video frame grabber capturing a video frame (X) from the video camera 18 and storing the video frame (X) within an image buffer at block 40. A next video frame (Y) is then captured by the second video frame grabber from the video camera 18 and is stored within the image buffer at block 42. Video frame grabs (X) and (Y) are then compared and a motion differential is calculated at block 44. If this calculated value indicates a significant motion differential (as shown in decision block 46), the motion differential is treated as a triggering event and video frame (Y) is recorded to the storage device at block 46. Whether or not video frame (Y) is stored, the video frame grabs (X) and (Y) are moved along (as shown in block 50) within the image buffer such that (Y) takes the place of (X) for the purpose of further comparison with the next video frame grabbed from the video camera 18. The second video frame grabber then captures a new video frame (Y) and stores the new (Y) within the image buffer (at block 42). The new (Y) is then compared with the immediately preceding video frame (X) at block 44 and so forth.

In addition, numerous other features could be implemented to enhance system functionality. Continuous frame grabbing and a pattern recognition process could be used within the observation system 10 to record a particular series of video frames having a recognized pattern from the video service device 14. This helps ensure that all relevant information has been recorded, even when the remote control signal detector 16 has missed a remote control button click.

Additionally, video frame grabs from the video camera 18 could be continuously captured at predetermined intervals and temporarily stored in an image buffer. The video frame grabs could be selectively recorded to the storage medium if a triggering event occurs. The selected video frame grabs recorded may include a series of pre-event video frames to provide more detail for later analysis.

Since the video frame grabs by both the first and the second video frame grabbers are under software control, it is possible to implement a wide variety of rules and conditions for recording the video frame grabs. For example, time of day sensitivity could be used, and motion sensitivity could be increased or decreased after remote control button clicks. The lapses between regular video frame grabs from the video camera 18 could be varied.

Although FIG. 1 shows a computer 12, video camera 18, video service device 14, and remote control signal detector 16 all separately arranged, alternatively, it is possible to integrate these devices to occupy a common housing such as within the set top box.

Since the exemplary observation system runs on ordinary PC computer hardware and Linux, it is easy to add network access to field-deployed boxes. Such access could be used to enable a near-real-time analysis and essentially unlimited recording capacity.

This invention makes it possible to unobtrusively observe users in a home-like environment while interacting with sophisticated video service devices. Such observations are necessary in order to determine how users employ the various capabilities of the video service device. Previous observation systems consisted of multiple parts and were not capable of capturing the entire range necessary for detailed analysis. Through the application of this system, experts could significantly improve the user interface design of software for sophisticated video service devices such as digital set top boxes and personal recorders. Further, increased understanding of how and when subscribers use such devices and the program menus could result in tailoring of video services to make them more attractive and competitive.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A computer-based method of monitoring and recording user interaction with a video service device, the video service device being connected to a display, the computer including a first video frame grabber, and a second video frame grabber, wherein the video service device is connected to the first video frame grabber, a video camera is connected to the second video frame grabber, and a remote control signal detector is connected to the computer, the computer being programmed to monitor and selectively record information received from the video service device, the video camera, and the remote control signal detector, the computer-based method comprising:
over a period of time, detecting a plurality of remote control signals with the remote control signal detector, each remote control signal being indicative of a remote control button click by the user;
over the period of time, grabbing a plurality of first video frames with the first video frame grabber from the video service device;
over a period of time, grabbing a plurality of second video frames with the second video frame grabber from the video camera; and
recording the detected remote control signals, the first video frames, and the second video frames to a storage device as a sequence of events over the period of time while preserving the time relationship among the various events with respect to each other thereby establishing a common time base for the recorded sequence of events.

2. The method of claim 1 further comprising:
in response to detecting a remote control signal with the remote control signal detector indicative of a remote control button click by the user, grabbing a sequence of first video frames with the first video frame grabber from the video service device.

3. The method of claim 2 wherein grabbing the sequence of first video frames further comprises:
if an additional remote control signal is detected while grabbing the sequence of first video frames, restarting a counter such that the grabbed sequence extends beyond the additional remote control signal detection.

4. The method of claim 1 further comprising:
recording a particular second video frame grabbed with the second video frame grabber from the video camera whenever the particular second video frame was preceded by a detected remote control signal.

5. The method of claim 1 further comprising:
recording a particular second video frame grabbed with the second video frame grabber from the video camera whenever the particular second video frame was preceded by an immediately previous second video frame that, when compared with the particular second video frame, indicates a significant motion differential.

6. The method of claim 1 wherein automatic video frame grabs from the video camera take place continuously and are temporarily stored in an image buffer for subsequent recording when dictated by recording rules.

7. A computer readable storage medium having instructions stored thereon to direct a computer to perform a method of monitoring and recording user interaction with a video service device, the video service device being connected to a display, the computer including a first video frame grabber, and a second video frame grabber, wherein the video service device is connected to the first video frame grabber, a video camera is connected to the second video frame grabber, and a remote control signal detector is connected to the computer, the computer being programmed to monitor and selectively record information received from the video service device, the video camera, and the remote control signal detector, the medium further comprising:
instructions for, over a period of time, detecting a plurality of remote control signals with the remote control signal detector, each remote control signal being indicative of a remote control button click by the user;
instructions for, over the period of time, grabbing a plurality of first video frames with the first video frame grabber from the video service device;
instructions for, over a period of time, grabbing a plurality of second video frames with the second video frame grabber from the video camera; and
instructions for recording the detected remote control signals, the first video frames, and the second video frames to a storage device as a sequence of events over the period of time while preserving the time relationship among the various events with respect to each other thereby establishing a common time base for the recorded sequence of events.

8. The medium of claim 7 further comprising:
instructions for, in response to detecting a remote control signal with the remote control signal detector indicative of a remote control button click by the user, grabbing a sequence of first video frames with the first video frame grabber from the video service device.

9. The medium of claim 7 wherein the instructions for grabbing the sequence of first video frames further comprises:
instructions for, if an additional remote control signal is detected while grabbing the sequence of first video frames, restarting a counter such that the grabbed sequence extends beyond the additional remote control signal detection.

10. The medium of claim 7 further comprising:
instructions for recording a particular second video frame grabbed with the second video frame grabber from the video camera whenever the particular second video frame was preceded by a detected remote control signal.

11. The medium of claim 7 further comprising:
instructions for recording a particular second video frame grabbed with the second video frame grabber from the video camera whenever the particular second video frame was preceded by an immediately previous second video frame that, when compared with the particular second video frame, indicates a significant motion differential.

12. The medium of claim 7 further comprising:
instructions for automatically and continuously grabbing video frames from the video camera and temporarily storing the video frame grabs in an image buffer for subsequent recording when dictated by recording rules.
